(19) United States
(12) Patent Application Publication
(10) Pub. No.: US 2007/0299725 A1
(43) Pub. Date: Dec. 27, 2007

(54) AIRLINE MEMBERSHIP PROGRAM

(76) Inventor: William J. Boyer, Kailua Kona, HI (US)

Correspondence Address: DAVIS WRIGHT TREMAINE, LLP/Seattle, 1201 Third Avenue, Suite 2200, SEATTLE, WA, 98101-3045, US

(21) Appl. No.: 11/670,305

(22) Filed: Feb. 1, 2007

Related U.S. Application Data
(60) Provisional application No. 60/771,714, filed on Feb. 9, 2006.

(51) Int. Cl. G06Q 30/00

(52) U.S. Cl. 705/14

(57) ABSTRACT

An airline membership program allows consumers to prepay a membership fee to the airline, and, in return, be given the right to obtain the lowest cost airline tickets without blackout dates or seat restrictions. The consumer signs up and provides personal identification data to the airline and obtains membership data therefrom. The member also prepays an annual membership fee, monthly membership fee, or the like. At a subsequent time, the member contacts the airline and purchases a ticket for a selected flight and receives a discounted airfare. The airline may also have business associates (e.g., hotels or rental cars) that will provide discounted goods and/or services to members of the airline membership program. The consumer may become a member of the airline membership program in person, via a travel agent or ticket agent, by telephone, or over computer network such as the Internet, using a computer device.

### CROSS REFERENCE TO RELATED APPLICATION

This application claims priority benefit of provisional application Ser. No. 60/771,714 filed Feb. 9, 2006, the content of which is incorporated in its entirety.

### BACKGROUND OF THE INVENTION

1. Field of the Invention

The present invention is directed generally to a method of operating a membership program and, more particularly, to a system and method for operation of an airline membership program.

2. Description of the Related Art

Airline travel has displaced bus and train travel as the preferred mode of long-distance transportation. Unfortunately, airline travel has also become very expensive and determination of airfares can be quite complex. For example, airlines may set aside a few seats for discount fares, which are then advertised, but often not available because of the severe seat limitation. Travel costs can also vary based on day of the week, time of the year and other factors associated with travel. Even when frequent flyers have accumulated sufficient mileage on an airline to qualify for a free upgrade or a free fare, such fares are often unavailable on a specific flight because of seat restrictions.

Therefore, it can be appreciated that there is a significant need for an airline membership program that will provide customers with the lowest possible cost airline tickets. The present invention provides this, and other advantages, as will be apparent from the following detailed description and accompanying figures.

### BRIEF DESCRIPTION OF THE SEVERAL VIEWS OF THE DRAWING(S)

FIG. 1 is a flowchart illustrating the operation of a conventional technique for purchase of an airline ticket.

FIG. 2 is a flowchart illustrating the operation of the airline membership program described herein.

### DETAILED DESCRIPTION OF THE INVENTION

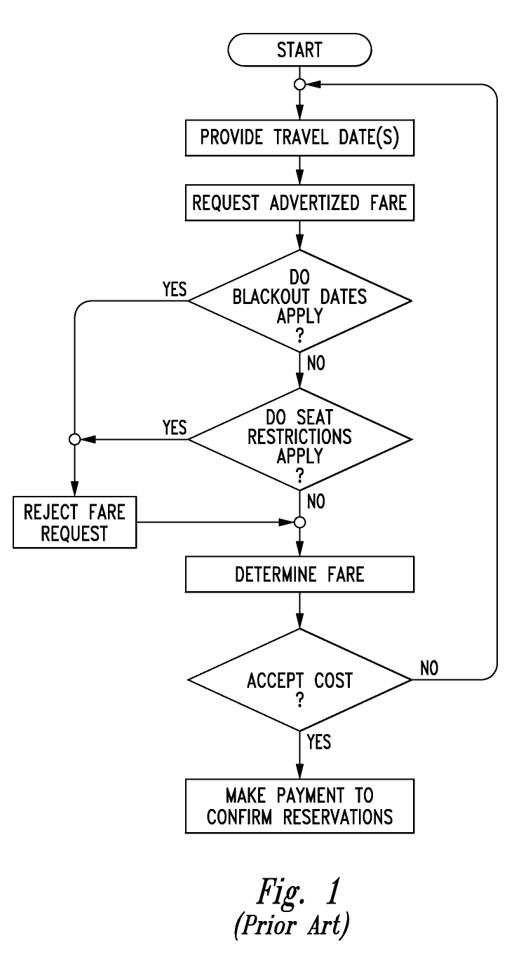

As previously noted, conventional airline ticket purchasing can be a complex procedure. FIG. 1 is a flowchart illustrating an example of the pitfalls of conventional airline ticket purchase. At a start, a passenger contacts an airline and provides travel date(s). This may be done by telephone or through a travel agent. With increased use of computers for online reservations, this process may also be performed with the consumer's personal computer.

Typically, the consumer requests the advertised airfare for the particular travel dates. The airline must determine whether the requested advertised fare has associated blackout dates. Blackout dates are typically days in which the airline expects heavy travel (e.g., during the Christmas holiday season) and does not permit any discount fares. If the requested dates are associated with a blackout period, the request for the advertised fare will be rejected and a higher priced ticket offered to the consumer.

Even assuming that blackout dates do not apply, the airline will then determine whether seats are available on the requested flight at the advertised price requested by the consumer. As previously noted, advertised pricing often applies to only a few seats on an airline and, therefore, only the first few travelers requesting the advertised price on that flight will receive the discounted fare. If a seat is not available at the requested discounted fare, due to seat restrictions, the request for the advertised fare will be rejected and a higher priced ticket offered to the consumer.

The consumer has the option of accepting the higher priced fare or rejecting it and attempting to arrange alternative date(s) to obtain a lower fare. If the consumer accepts the higher price, the consumer will make payment to confirm the reservation and the reservation process ends.

The blackout dates and seat restrictions often confuse and frustrate the consumer. The consumer often settles for a higher priced ticket and a high state of dissatisfaction with the airline. Even when the consumer gets the advertised price by altering travel dates and/or travel times, the process leaves the consumer dissatisfied with the airline.

In contrast, the airline membership program described herein allows the purchase of airline tickets without blackout dates, seat restrictions, and the like. The member is entitled to a discount fare any day and any time. Thus, the member always receives the lowest fares with no pricing gimmicks or alternatively, a fare discounted for members.

In an exemplary embodiment, the member prepays an annual fee. In one embodiment, the annual fee is a flat fee. The member will receive the travel discount no matter how many times the member flies during the year.

In an alternative embodiment, the membership fee may be graduated based on the number of expected flights by the member during the course of the year. For example, a flat membership fee of $99 will entitle the member to discounts on one to four flights during the year. A higher fee (e.g., $150 a year) allows the member to obtain the discounted airfares on five or more flights per year.

The membership fees described above apply to individuals. In another alternative embodiment, a member may add additional individuals (e.g., family members) for an additional membership fee. Typically, the additional member fees are lower than the individual member fee. For example, a flat fee of $99 per year may apply to the individual, with an additional annual fee of $39.95 per person for up to four additional family members.

In yet another alternative embodiment, an individual user may sign up for a one-year contract and pay a monthly fee rather than an annual flat fee. For example, an individual user may sign a one-year membership agreement and pay $9.95 per month. This payment program could prohibit additional family members or, in an alternative, include family members for an additional monthly fee. Other pricing options are within the scope of this disclosure.

Those skilled in the art will appreciate that the membership program provides a more predictable cash flow to the airline, while at the same time allowing the member consumer to obtain the lowest possible cost without the frustrating blackout dates and seat restrictions imposed by other airlines.

In an exemplary embodiment, a consumer may join an airline membership program using conventional on-line techniques. In a typical embodiment, the user navigates to the airline website and selects a link to the airline membership program. Following the entry of personal data (i.e., identification data), the consumer selects the appropriate membership plan and provides credit card information to pay the annual flat fee (or monthly fee if a different program option is selected).

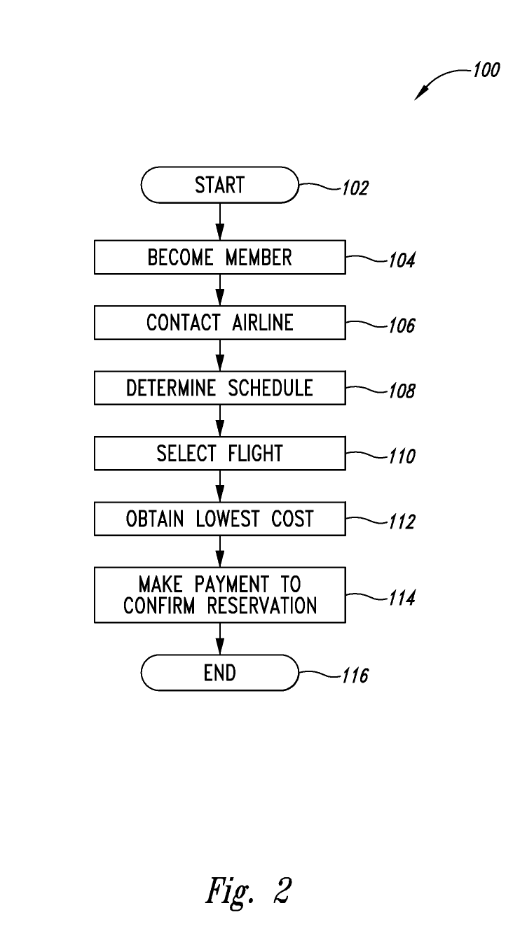

Flowchart 100, shown in FIG. 2, illustrates the operation of the airline membership program. At a start 102, the consumer makes a decision to become a member. At step 104, the consumer provides the necessary personal information to become a member. As previously noted, a personal computer may be readily employed to permit online membership registration. Alternatively, those skilled in the art will appreciate that an individual can sign for the airline membership program over the telephone or in person at the airline counter, or via a travel agent or ticket agent. Those skilled in the art will appreciate that any of the above-described techniques may be used alone or in combination, along with other known techniques, to perform the initial membership registration.

Once the consumer has become a member in the airline membership program, the member may contact the airline, shown in step 106 of FIG. 2, and determine the airline's schedule at step 108. In some situations, the member may already know the schedule based on past experience. In this case, step 108 is unnecessary. In step 110, the consumer selects a flight and, at step 112, obtains the lowest cost airfare. It should be noted that steps 106-112 can also be performed by a variety of different procedures. For example, in one embodiment, the member may perform steps 106-112 using a computer over a network, such as the Internet, to make the desired reservations. However, those skilled in the art will appreciate that steps 106-112 may be executed via a telephone call to the airline, travel agent, ticket agent, or the like. In yet another alternative embodiment, the consumer may simply go directly to the airport and make the desired ticket purchase for a flight the same day (i.e., a walk up last minute purchase without any extra fees imposed) or for a flight on a subsequent date. While it can be appreciated that any particular flight may be completely sold out, the airline membership program described herein will permit the member to obtain the lowest cost fare, even for last-minute ticket purchases without penalties or extra fees imposed, such as described above. Thus, the membership program process is not limited by the specific form or manner in which the member obtains the desired airline ticket.

In step 114, the member makes payment to confirm the reservation or purchase the ticket and the process ends at 116. Thus, the airline membership program qualifies the member to purchase the lowest cost tickets in exchange for the prepaid membership fees. In the embodiment described, there are no advance purchase requirements or travel time limitations imposed on the member to obtain the lowest fare and there are no penalties or extra fees imposed. As noted above, in one exemplary embodiment the member will receive the travel discount no matter how many times the member flies during the year (i.e., unlimited discounted air travel at the lowest fare is permitted for a member). This allows the member great freedom in obtaining the lowest cost fare for the flight desired on the day of travel desired without requiring the ticket purchase be made far in advance, thereby providing maximum consumer freedom and convenience in addition to low price. In turn, the prepaid membership fees provide vital and predictable cash flow to the airlines.

In yet another alternative embodiment, the airline membership program may entitle the member to additional prearranged discounts at local hotels, car rental agencies, restaurants, and the like. Specific details of the membership discount at other local businesses may vary. For example, member hotels may charge a flat fee discount, discount a predetermined percentage off the total bill, free room upgrades, or the like. Similarly, discounts with rental car agencies may provide a flat fee rental price (e.g., $29.95 per day), a predetermined discount (e.g., $10 discount per day, rent six days and get the seventh day free, and the like), rental car upgrade, and the like.

Local restaurants may also provide discounts to the airline member. For example, the local restaurant may provide a flat fee discount or a percentage discount. Alternatively, the restaurant may offer airline members other amenities, such as a free appetizer, buy one meal, get one free, or the like.

The discounts from local businesses described above (i.e., hotels, rental cars, and restaurants) are all travel oriented. However, other local businesses may provide additional discounts to the airline members that may be travel-related or not. For example, a local clothing store or a record store could provide discount programs similar to those described above. Thus, auxiliary discount programs available to the airline membership program member are not limited only to travel-related businesses.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

The invention claimed is:

1. A method for operating an airline membership program comprising: for new members:
accepting user identification data;
accepting user payment of a predetermined membership fee;
providing member identification data to the user; for existing members:
accepting member identification data;
accepting member selection of a flight operated by the airline; and
providing an airfare ticket to the member at a member discounted price.

2. The method of claim 1 wherein the predetermined membership fee is a prepaid annual fee.

3. The method of claim 1 wherein the predetermined membership fee is a monthly fee.

4. The method of claim 1, further comprising accepting user data for a new member related to an existing member to permit membership of the related new member.

5. The method of claim 4, further comprising accepting additional user payment of an additional predetermined membership fee for the related new member.

6. The method of claim 1, further comprising using the member identification at a business other than the airline to obtain discounted goods and/or services at the business.
